(19) United States
(12) Patent Application Publication
(10) Pub. No.: US 2006/0071004 A1
(43) Pub. Date: Apr. 6, 2006

(54) Method for producing a container for a pressurized fluid, and container of this type

(76) Inventor: Maurice Gerardus Maria Ven Giezen, Vogelenzang (NL)

Correspondence Address: STEVENS DAVIS MILLER & MOSHER, LLP, 1615 L STREET, NW, SUITE 850, WASHINGTON, DC, 20036, US

(21) Appl. No.: 10/501,989

(22) PCT Filed: Oct. 17, 2002
(86) PCT No.: PCT/NL02/00659

§ 371 Date: Nov. 8, 2005

(30) Foreign Application Priority Data
Oct. 17, 2001 (NL) 1019185
Sep. 30, 2002 (NL) 1021563

(51) Int. Cl. F17C 1/00

(52) U.S. Cl. 220/581

(57) ABSTRACT

The invention relates to a method for producing a container for holding pressurized fluid, which container comprises a circumferential wall, a base and if desired a top, at least the circumferential wall being made from metal. According to the invention, the circumferential wall is produced by hydroforming before the base and, if desired, the top are attached to the circumferential wall. The invention also relates to a container produced using the method.

The invention relates to a method for producing a container for holding pressurized fluid, which container comprises a circumferential wall, a base and if desired a top, at least the circumferential wall being made from metal. The invention also relates to a container produced using the method.

Containers of this type are used for various applications. The smaller sizes can be used, for example, to hold personal care products, such as shaving foam. The larger sizes are used, for example, as beer barrels. The base and the top may be made from metal, although it is also possible to use a plastics material for the base and top. In the top, there needs to be an opening for a filling/dispensing device to be fitted to. If the top side of the circumferential wall has small dimensions, the top can be omitted and the filling/dispensing device can be connected directly to the circumferential wall.

Beer barrels usually have a volume of 10 to 50 liters and are filled by the brewer, transported to the customer and returned when they are empty.

One drawback of these known barrels is that they are heavy compared to the volume transported. For example, a beer barrel for 30 liters of beer (i.e. 30 kilos of beer) has a weight of approximately 10 kilos. In many cases, therefore, the weight is the limiting factor in the transport of beer, rather than the volume. The return transport of empty beer barrels is also a high cost factor in the logistics.

Containers for personal care products usually have a volume of a few hundred milliliters. One drawback of this type of containers with a metal circumferential wall is that the possible shapes are limited, and consequently these containers are generally made from plastics.

It is an object of the invention to provide a method for producing a container with which it is possible to achieve a considerable freedom in the shape of the circumferential wall.

It is another object of the invention to provide a container for transporting a pressurized fluid which is lightweight.

It is a further object of the invention to provide a container for transporting a pressurized fluid which reduces the logistics costs.

Yet another object of the invention is to provide a container for a pressurized fluid which increases ease of use for the end user of the container.

It is also an object of the invention to provide a container for transporting a pressurized fluid which is inexpensive compared to the known containers.

According to a first aspect of the invention, one or more of these objects is achieved by a method for producing a container for holding pressurized fluid, which container comprises a circumferential wall, a base and if desired a top, at least the circumferential wall being made from metal, in which method the circumferential wall is produced by hydroforming before the base and if desired the top are attached to the circumferential wall.

The fact that the circumferential wall is produced by hydroforming results in numerous advantages. Hydroforming is a known technique which is used, for example, in the automotive industry to provide hollow profiled sections for, for example, the A pillar of the body with the desired shape. Starting from a cylindrical tube, this tube can be pressed into numerous shapes by hydroforming. For this purpose, the tube is placed into a mold and is forced into the interior shape of the mold with the aid of high-pressure liquid, with the result that the tube acquires a different, generally larger circumference as a result of the closing of the mold and at the locations where the mold allows so, under the influence of the pressurized liquid.

The merit of the present invention is that it has been recognized that this technique can also be used to produce containers, such as beer barrels. By producing a tube section of the desired length with the aid of hydroforming, it is possible to provide the circumferential wall of the container with a shape which is such that it is rigid and able to withstand impact forces. The use of a thin-walled tube makes it possible to achieve a considerable weight saving. As a result of the hydroforming being carried out before the base and if appropriate the top have been fitted, the hydroforming equipment is of simple design and the method is quick to carry out.

It is preferable for the circumferential wall which is to be hydroformed to be produced as a tubular blank. A tubular blank is a blank which has been formed by shaping into a tube with virtually any desired cross-sectional shape, the longitudinal edges then having been welded to one another with the aid of a welding process. A circumferential wall which has been formed in this way is easy to produce in various dimensions and with low wall thicknesses. With the current prior art, it is possible to achieve a wall thickness: diameter ratio of 1:250 for round tubes. Laser welding or seam welding are very suitable forms of welding.

According to a preferred possibility, the tubular blank is produced as a tailored tubular blank, more preferably as a tailored tubular blank with sections of different thicknesses. This means, for example, that the blank may be produced from various grades of steel or from different sections with different thicknesses. In this way it is possible, for example, to make the central part of the circumferential wall thicker than the ends. The rigidity and strength of the beer barrel can in this way be increased where necessary while the weight remains as low as possible.

According to a preferred embodiment, the circumferential walls for two or more containers are hydroformed as a single unit. By way of example, three or four circumferential walls which are fixed to one another can be formed from one tube using one hydroforming operation and then simply have to be separated from one another. In this way, a number of circumferential walls can be formed simultaneously in a highly economic way, which is not possible if the base and if desired the top have been attached to the circumferential wall prior to the hydroforming.

It is preferable for the circumferential wall to be substantially round, oval, triangular, rectangular or square in cross section prior to the hydroforming. A round cross section is a cross section which is in widespread use for a barrel, such as a beer barrel; an oval cross section is also used for containers with a small volume, such as containers for personal care products. However, hydroforming can also be used with great success on circumferential walls with a different cross section, and substantially triangular, rectangular and square cross sections are very suitable cross sections since the containers then take up much less space during transport and storage than containers which are substantially round or oval in cross section.

According to another preferred embodiment, the circumferential wall has a substantially cylindrical or conical shape prior to the hydroforming. A cylindrical shape (in which the cross section is identical at any height but does not have to be circular) is a very standard starting shape for hydroforming, for example a substantially square or round piece of tube. However, a conical shape also has advantages, since the container formed with this cross-sectional shape has to have a base but does not have to have a separate top. The hydroforming of a conical circumferential wall according to the invention is also advantageous since, according to the invention, the base is not yet present during the hydroforming. Hydroforming of a conical circumferential wall with a base is difficult, since it is then hard to gain access to the interior of the container.

It is preferable for the base and/or the top to be made from plastics materials, preferably from a thermoplastic, more preferably from polyethylene. By making the base and, if present, the top from plastics, it is possible to save weight compared to metal. It is then also easy for the base and top to be secured to the circumferential wall, for example by means of a clamping, threaded or bayonet connection. Using a thermoplastic makes the base and top easy to produce. A base and top made from polyethylene has the advantage that these components can be burnt without problems after use.

According to an advantageous preferred embodiment, a container having a base and a top made from plastics material is produced, and the base and the top are connected to one another with the aid of a rigid tie rod. If a container with a base and top made from plastics is used as a beer barrel with a volume of, for example, liters, there is a risk of the base and the top being deformed under the influence of the internal pressure. To counteract this, the base and the top would have to have a greater thickness, which is undesirable. As a result of a tie rod being fitted between the base and top, this tie rod being rigid in its longitudinal direction, it is not possible for deformation of this type to occur, and the base and the top can be thin, which is favorable in terms of both consumption of materials and weight.

It is preferable for the base, top and tie rod to be produced as a single unit. This simplifies assembly of the beer barrel.

According to a preferred embodiment, the rigid tie rod is of at least partially hollow design so that it can be used as a discharge passage for fluid in the container. In this way, for example for beer barrels, there is no need for a separate discharge hose in the container in order to pump out the beer.

It is preferable for the circumferential wall to be deformed by hydroforming in such a manner that parts of the circumferential wall can be used as a handle or as an attachment point for a handle which is to be attached. As a result, it is either not necessary to attach a separate handle or easy to attach such a handle.

According to an advantageous embodiment of the method, the base and if appropriate the top are releasably secured to the circumferential wall. This has the advantage that after the container has been used, the metal circumferential wall and the plastic base and top can be separated, so that they can be disposed of separately and the metal can be reused and the plastic can, for example, be burnt.

A second aspect of the invention provides a container for holding a pressurized fluid, produced using the method as described above, which has a volume of at least 1 liter and at most 100 liters, preferably a volume of at least 5 liters, and more preferably a volume of approximately 30 liters.

Containers with a volume of this type are used primarily as barrels for liquids, in particular for beverages.

It is preferable for the container to be able to withstand a maximum operating pressure of 12 bar, preferably a maximum operating pressure of 6 bar. Pressures of this level are standard for carbonated beverages.

According to a preferred embodiment, the circumferential wall has a thickness of between 0.2 and 2.0 mm, preferably between 0.2 and 1.0 mm, depending on the volume of the container. A larger container will require a greater wall thickness, in relative terms. However, these wall thicknesses are sufficient to provide the container with the desired strength and rigidity, and these wall thicknesses are much smaller than the standard wall thicknesses of containers which are used for pressurized fluids at the present time.

It is preferable for the circumferential wall to have a cross section with a dimension of at most 500 mm, preferably at most 400 mm. A container with a diameter of 500 mm is, for transport purposes, the maximum size which can be lifted by one person, obviously depending on the height and volume of the barrel. A maximum diameter of 400 mm is more usual in view of the containers which are currently in use for beverages.

According to a preferred embodiment, the container is a beer barrel. A container with a low weight compared to the volume is very important in particular for beer barrels.

It is preferable for the container to be designed in such a manner that containers which are stacked on top of one another fit inside one another in nesting fashion. The containers can then easily be stacked on top of one another without readily falling over. The containers are generally formed in such a way that the base of a barrel engages over an edge at the top of the barrel below it, or vice versa.

According to a preferred embodiment, marks are incorporated in the circumferential wall, which have been formed in the circumferential wall by hydroforming, such as a name, a symbol and/or an instruction. A mark can easily be formed in relief in the circumferential wall by hydroforming, for example the name and/or logo of the brewer, or an instruction relating to how to use the container. The marks may also comprise a texture made in the circumferential wall.

According to another preferred embodiment, there are deformations in the circumferential wall in order to strengthen the circumferential wall, which deformations have been formed in the circumferential wall by hydroforming, for example reinforcing ridges. Applying these deformations with the aid of hydroforming means that the reinforcements can be applied efficiently and the reinforcements do not have to be detachable in the longitudinal direction, as is the case with deep-drawing, for example.

It is preferable for attachment points for connecting pieces for connecting two or more containers also to be formed in the circumferential wall, which attachment points have been formed by hydroforming. Connection pieces of this type can be used to attach a number of containers to one another and transport them in this state without it being necessary to place these containers onto a pallet. This saves space and weight during transport.

According to a preferred embodiment, the container is provided with a base and a top made from plastics material, which base and top are preferably connected to one another by a rigid tie rod. This provides a container which is easy to assembly, is rigid if a tie rod is used while consuming the minimum possible amount of material, and can readily be recycled.

The container is preferably suitable for single use. A container with a hydroformed circumferential wall is eminently suitable for this purpose, since it comprises little metal, preferably steel, since the wall thickness is low compared to the diameter. There is much less metal in a hydroformed container than in a conventional container, and consequently, compared to the current situation, it can be economically more favorable not to return an empty container to the brewer, for example, in the case of a beer barrel, but rather to consider it a disposable container. To determine whether or not this is the case, it will be necessary to look at the ecobalance of the container, taking into consideration not only the transport energy but also, for example, the cleaning and storage. The likely result is that for transport over relatively great distances, for example for export, the ecobalance of a container according to the invention, such as a beer barrel, will be such that single use is more ecologically favorable than return. This may also be favorable for the design of the barrel, since the contents of the barrel can make a partial contribution to the rigidity and strength of the barrel, so that the wall thickness of the circumferential wall could be made thinner than if the container also has to be transported empty.

The invention will be explained with reference to a number of exemplary embodiments.

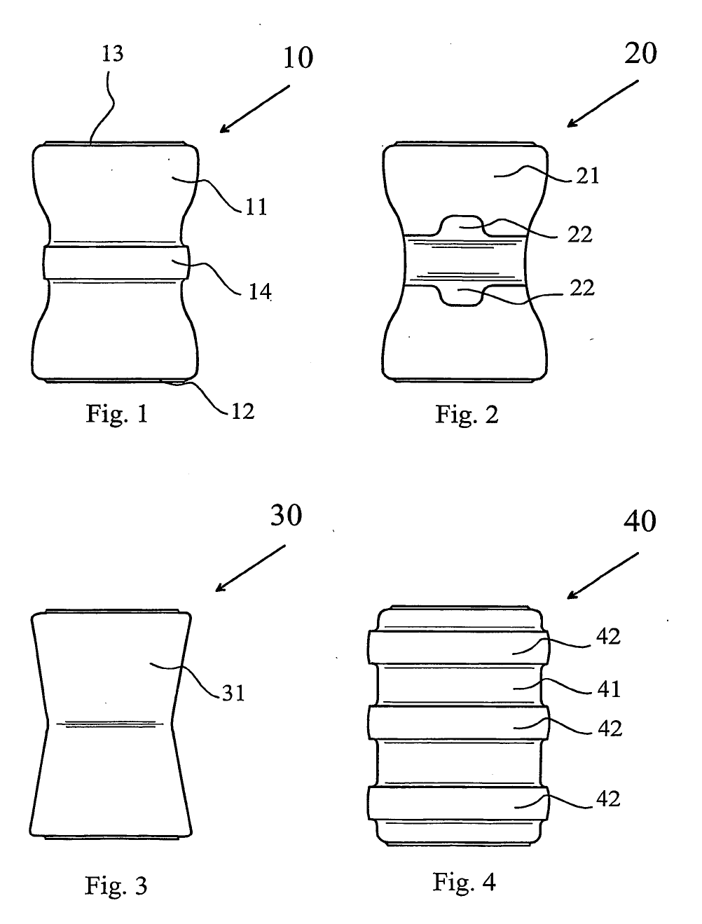

FIGS. 1 to 8 show sketches illustrating seven different exemplary embodiments of the container according to the invention.

FIG. 1 diagrammatically depicts a barrel 10 with a circumferential wall 1, a base 12 and a top 13. The circumferential wall is provided with a waist as a result of the ends of the original tube being provided with a greater diameter by hydroforming. This tube can be produced as a tailored tubular blank, the projecting rim 14 halfway up the circumferential wall 11 having a greater thickness than the remainder of the circumferential wall. For example, the projecting rim may have a thickness of 0.8 mm and the remainder of the circumferential wall may have a thickness of 0.6 mm. These thicknesses depend, inter alia, on the volume of the barrel. It can also be seen that the rim 14 has acquired a slightly larger diameter as a result of the hydroforming. In the top there will be an opening for filling and emptying the barrel 10.

FIG. 2 diagrammatically depicts a barrel 20 with a circumferential wall 21, handles 22 having been formed in the circumferential wall by hydroforming. These handles 22 are recessed in the circumferential wall, and also in the rear side of the circumferential wall, which cannot be seen in the figure. By means of the handles, the barrel can easily be lifted and carried both upright and upside-down.

FIG. 3 shows a barrel 30 with a circumferential wall 31 in the shape of a diabolo created by hydroforming, so that this barrel is highly resistant to bulging (high rigidity).

FIG. 4 shows a barrel 40 with a circumferential wall 41 with three projecting rims 42, making this barrel very rigid. If a tailored tubular blank is used as the tube from which the circumferential wall is formed by hydroforming, the projecting rims may have a greater thickness than the remainder of the circumferential wall. In this case, the projecting rims 42 serve not only as a reinforcement but also as abutting edges during transport of the barrel.

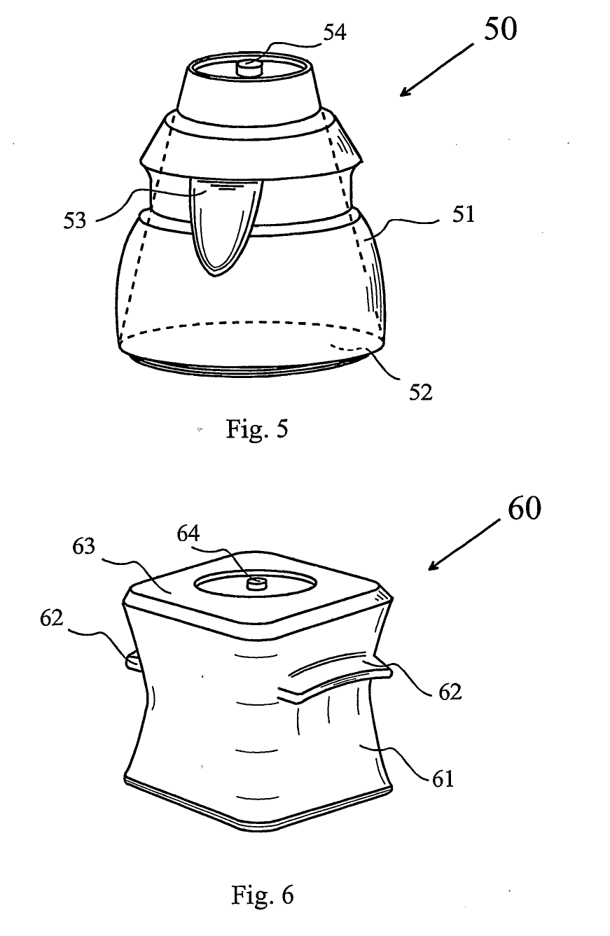

FIG. 5 shows a barrel 50 with a circumferential wall 51 and a base 52 (shown in dashed lines, not visible) as in the previous examples, but without a separate top. This barrel has been produced by hydroforming from a conical preform, as indicated by the dashed lines. The central section of the conical preform has been considerably inflated by the hydroforming, with the result that this barrel still has a large volume. Two inwardly projecting handles 53 have been formed integrally in the circumferential wall by the hydroforming. The top side is closed off by a separate seal 54, which seal can be removed and replaced by a filling device or a discharge device.

FIG. 6 shows a barrel 60 which is substantially square in cross section and in which the top and bottom sections of the circumferential wall 61, as a result of the hydroforming, have a greater length and width than the center of the circumferential wall. In this barrel, projecting rims 62 have been integrally formed along opposite sides of the top part of the circumferential wall with the aid of the hydroforming, and the barrel can be lifted and carried by means of this rim. The top 63 with filling and discharge openings 64 can also be seen.

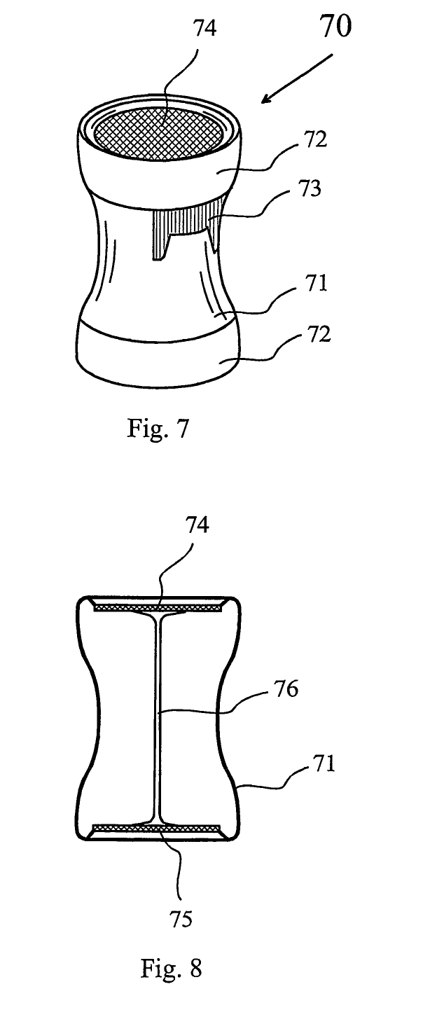

FIG. 7 shows a barrel 70 with a substantially circular cylindrical circumferential wall 71 which has a top section 72 and a bottom section 73 with a larger diameter than the central section. If desired, the sections 72 and 73 may be formed from material with a greater wall thickness. Two handles 73 are arranged below the top section 72 (only one of these handles can be seen). The hydroforming of the circumferential wall 71 allows the circumferential wall to be shaped at the location of the handles in such a manner that the handles can easily be fitted, for example by being clipped into place.

The base (not visible) and the top 74 of the container 70 are formed from plastics material, preferably from polyethylene. A filling and discharge opening (not shown) is present in the top.

FIG. 8 shows a cross section through the container 70 shown in FIG. 7. This figure shows the top 74, the base 75 and a tie rod 76 which connects the base and the top. This tie rod has to be rigid in the longitudinal direction and imparts rigidity to the base and the top, so that they will be deformed by the internal pressure in the container 70. The tie rod 76 may be of partially hollow design (not shown) in order to discharge pressurized liquid from the container. There is no need for a separate discharge hose in that case.

The base and the top side of the barrels shown are preferably shaped in such a way that the barrels can be stacked on top of one another in nesting fashion. Obviously, the top side of the barrel will preferably be provided with an opening to allow filling and emptying of the barrel.

In all cases, marks may also be integrally formed in the circumferential wall during the hydroforming of the wall, for example a name, logo or instruction.

In many cases, reinforcements will also be formed integrally in circumferential walls with a smooth outer side, for example reinforcing ridges, in order to provide the container with greater rigidity.

If containers are to be used as disposable (single use) containers, it may be advantageous to use a separate liner (not shown) which is fitted into the container. A liner of this type, which is usually made from plastics, is easier to sterilize internally than the interior of a metal container. The liner will be in communication with the filling and dispensing opening. It will be possible to connect the liner to the top or a filling device, such as 54 in FIG. 5. The liner may also be connected to both the base and the top, in which case the tie rod may be accommodated in the liner.

1. A method for producing a container for holding pressurized fluid, which container comprises a circumferential wall, a bases and optionally a top, at least the circumferential wall being made from metal, wherein the circumferential wall is produced by hydroforming before the bases and optionally the tops are attached to the circumferential wall and wherein the circumferential wall which is to be hydroformed is produced as a tubular blank.

2. The method as claimed in claim 1, in which the circumferential wall which is to be hydroformed is produced as a tabular tubular blank, optionally as a tailored tubular blank with sections of different thicknesses.

3. The method as claimed in claim 1, in which the circumferential walls for two or more containers are hydroformed as a single unit.

4. The method as claimed in claim 1, in which the circumferential wall, prior to the hydroforming, has a substantially round, oval, triangular, rectangular or square cross section and/or a substantially cylindrical or conical shape.

5. The method as claimed in claim 1, in which the base and/or the top are made from plastics, preferably from a thermoplastic, more preferably from polyethylene.

6. The method as claimed in claim 5, in which a container is produced with a base and a top made from plastics material, and the base and the top are connected to one another with the aid of a rigid tie rod.

7. The method as claimed in claim 6, in which the base, top and tie rod are produced as a single unit.

8. The method as claimed in claim 6, in which the rigid tie rod is designed to be at least partially hollow, in order to act as a discharge passage for fluid in the container.

9. Method according to claim 1, in which the circumferential wall is deformed by hydroforming in such a manner that parts of the circumferential wall can be used as a handle or as an attachment point for a handle which is to be attached.

10. The method as claimed claim 1, in which the base, and optionally the top, are releasably secured to the circumferential wall.

11. A container for holding a pressurized fluid, produced using the method as described in claim 1, wherein the container has a volume of at least 1 liter and at most 100 liters, preferably a volume of at least 5 liters and more preferably a volume of approximately 30 liters.

12. The container as claimed in claim 11, which is able to withstand a maximum operating pressure of 12 bar, preferably a maximum operating pressure of 6 bar.

13. Container as claimed in claim 12, in which the circumferential wall has a thickness of between 0.2 and 2.0 mm, preferably between 0.2 and 1.0 mm, depending on the volume of the container.

14. The container as claimed in claim 11, in which the circumferential wall has a cross section with a dimension of at most 500 mm, preferably at most 400 mm.

15. The container as claimed in claim 11, which is a beer barrel.

16. The container as claimed in claim 11, which is designed in such a manner that containers stacked on top of one another fit into one another in nesting fashion.

17. The container as claimed in claim 11, in which marks are incorporated in the circumferential wall, these marks being formed into the circumferential wall by hydroforming, for example a name, a symbol and/or an instruction.

18. The container as claimed in claim 11, in which there are deformations in the circumferential wall in order to reinforce the circumferential wall, which deformations are formed in the circumferential wall by hydroforming, for example reinforcing ridges.

19. The container as claimed in claim 11, in which attachment points are formed integrally in the circumferential wall for connecting pieces for connecting two or more containers, which attachment points are formed by hydroforming.

20. The container as claimed in claim 11, which is provided with a base and a top made from plastics material, which base and top are optionally connected to one another by a rigid tie rod.

21. The container as claimed in claim 11, which is suitable for single use.
